(19) United States
(12) Patent Application Publication
(10) Pub. No.: US 2011/0005190 A1
(43) Pub. Date: Jan. 13, 2011

(54) KEROSENE BASE FUEL

(76) Inventors: Joanna Margaret Bauldreay, Cheshire (GB); Vijay Nair, Katy, TX (US); Augustinus Wilhelmus Maria Roes, Houston, TX (US); James Timothy Talbert, Baytown, TX (US)

Correspondence Address: SHELL OIL COMPANY, P O BOX 2463, HOUSTON, TX, 772522463, US

(21) Appl. No.: 12/922,943

(22) PCT Filed: Mar. 17, 2009
(86) PCT No.: PCT/US09/37414

§ 371 Date: Sep. 16, 2010

Related U.S. Application Data
(60) Provisional application No. 61/037,138, filed on Mar. 17, 2008.

(51) Int. Cl. F02C 3/20; F02B 43/00; C10L 1/04; C10L 1/10

(52) U.S. Cl. 60/39.461; 123/1 A; 44/300; 208/15

(57) ABSTRACT

The subject invention relates to a kerosene base fuel having an initial boiling point in the range 130 to 160° C. and a final boiling point in the range 250 to 300° C. as determined according to ASTM method D86, and comprising less than 15% by weight of aromatic compounds, and at least of 80% by weight of aliphatic hydrocarbons, of which at least 20% by volume are n-paraffins and at least 25% by volume are cycloparaffins, as determined by according to ASTM method D2425. It further relates to the use of this base fuel in fuel compositions, as well for he use of the kerosene base fuel in a fuel composition comprising a petroleum based kerosene base fuel having a higher density and a lower energy content than that of the kerosene base fuel, to increase the energy density above that of the petroleum derived kerosene fuel.

### FIELD OF THE INVENTION

The present invention relates to a novel kerosene base fuel, its preparation from kerogen materials, the use of the kerosene base fuel as a blending component and methods comprising the use of the kerosene base fuel in power units, particularly aviation engines such as jet engines and (aero) diesel engines.

### BACKGROUND OF THE INVENTION

Oil shale is a fine-grained sedimentary rock containing significant amounts of kerogen, a solid mixture of hydrocarbons. Oil shale has gained considerable attention recently as an energy resource as the price of conventional sources of petroleum has risen.

Oil shale has been traditionally mined for use as a low-grade fuel for power generation and heating purposes, and as a raw material in the chemical and construction materials industries. When heated to a sufficiently high temperature, a so-called shale oil and combustible shale gas is yielded, as described for example in Ullman's Ecyclopedia of Industrial Chemistry, Fifth Edition, Volume 18A, VCH Publishers, 1991, 101-126.

A different approach to produce useful materials from the kerogen embedded in the oil shale is the in-situ conversion process utilizing downhole heaters, as described in detail for instance in U.S. Pat. No. 2,634,961, U.S. Pat. No. 2,732,195,U.S. Pat. No. 2,780,450, U.S. Pat. No. 2,789,805, U.S. Pat. No. 2,923,535, U.S. Pat. No. 4,886,118, U.S. Pat. No. 2,914,309, U.S. Pat. No. 4,344,483, U.S. Pat. No. 4,067,390, U.S. Pat. No. 4,662,439, U.S. Pat. No. 4,384,613, U.S. Pat. No. 2,923,535, U.S. Pat. No. 4,886,118 and EP-A-1276959. This process treats a hydrocarbon containing formation underground, and produces a hydrocarbon fluid from the formation by pyrolysing hydrocarbons present in the formation.

Conventional reforming of shale oil produced liquid products that had boiling points in the range of kerosene fuels. However, these products were found to be only of limited usefulness as fuels, due to their low thermal stability and low smoke points.

### SUMMARY OF THE INVENTION

It has now been found that the pyrolysis product of kerogen in oil shale can be converted to a kerosene base fuel having a high thermal stability, a high energy content, and a relatively low density.

Accordingly, the present invention provides a kerosene base fuel having an initial boiling point in the range 130 to 160° C. and a final boiling point in the range 250 to 300° C. as determined according to ASTM method D86, and comprising less than 15% by weight of aromatic compounds, and at least 80% by weight of aliphatic hydrocarbons, of which at least 20% by volume are n-paraffins and at least 25% by volume are cycloparaffins, as determined by according to ASTM method D2425. The invention further provides a fuel composition comprising 0.1 to 99.9 volume % of such kerosene base fuel and further at least one additive.

In addition the invention provides a use of such kerosene base fuel to increase the thermal stability in a fuel composition and a use of such kerosene base fuel as a blending component.

Furthermore the invention provides a method of operating a jet engine or a compression ignition (diesel) engine and/or an aircraft which is powered by one of more of said engines, which method involves introducing into said engine a fuel composition comprising the kerosene base fuel.

### DETAILED DESCRIPTION

Within the context of this application, the term “aliphatic hydrocarbons” includes paraffins (n- and iso-paraffins) as well as cycloparaffins, otherwise also known as naphthenic compounds. The term naphthenic aromatic compounds herein describes alkyl benzenes and higher annulated aromatic ring systems with alkyl side chains. Monoaromatic compounds are compounds having one aromatic ring structure, while diaromatic compounds have two aromatic ring structures, while triaromatic compounds have three aromatic ring structures. The term “base fuel” as used herein determines a fuel component that can be used either neat, additized, or as blending component.

The kerosene base fuel according to the invention was surprisingly found to have a very high thermal stability when compared to mineral crude derived hydrotreated kerosene compositions. This stability was particularly high at elevated temperatures, such as temperatures above 340° C., as illustrated by the Jet Fuel Thermal Oxidation Test (JFTOT, as determined according to ASTM method D3241). The Jet Fuel Thermal Oxidation Test method covers the procedure for rating the tendencies of gas turbine fuels to deposit decomposition products within the fuel system.

The kerosene base fuel according to the invention, when comprising about 20 mg/l of Ionox 75 as standard antioxidant, has been found to have a passing rating in ASTM D3241 (describing the JFTOT procedure) for 2.5 hours at 260° C. Further tests were performed to quantify the fuel's thermal stability performance beyond the standard JFTOT test at 260° C. It was found that the kerosene base fuel according to the invention has a passing rating in ASTM D3241 (describing the JFTOT procedure) for 2.5 hours at 300° C., at 320° C., at 340° C., at 360° C., and even above 360° C. A passing rating corresponds to a tube rating of less than 3 and a pressure drop across a filter of less than 25 mm Hg. The highest JFTOT passing temperature, is usually denominated as the “JFTOT breakpoint”. The kerosene base fuel according to the present invention, when comprising about 20 mg/l of Ionox 75 as standard antioxidant, was found to have a JFTOT breakpoint above 340° C., above 360° C., and even above 370° C.

The subject invention further also provides the use of a kerosene base fuel according to the invention to increase the thermal stability in a fuel composition.

The kerosene base fuel according to the invention preferably comprises a very low amount of aromatic compounds. Preferably, the aromatic compounds comprise equal to or less than 5% w monoaromatic compounds. Further, the aromatic compounds preferably comprise less than 0.1% w diaromatic compounds. In the kerosene base fuel according to the invention, the ratio of monoaromatic compounds to diaromatic compounds is preferably above 9.0, as determined by ASTM method D6379.

The kerosene base fuel preferably comprises less than 0.001% w of tri- or higher polyaromatic compounds.

The aromatic compounds are thus preferably largely composed of monoaromatic compounds. Preferably the majority of these are alkyl benzenes, otherwise known as naphthenic monoaromatic compounds. Accordingly, preferably more then 50% of the aromatic compounds are napththenic aromatic compounds.

As set out in U.S. Pat. No. 2006/0138022, the range of an acceptable density at 15° C. for Jet A and Jet A-1 ranges from 775 to 840 kg/m³ (as determined according to ASTM D 1655). Lower density is usually considered to reduce the flight range for volume-constricted aircraft. Fischer-Tropsch derived kerosene fuels for instance, which comprise solely n-paraffins or iso-paraffins, usually have very low densities, combined with a low density outside the minimum requirement. The volumetric energy content of such fuels may be considered as too low. The fuel according to the invention was found to have a surprisingly high energy content at a relatively low density, thereby overcoming the above issue with Fischer-Tropsch derived kerosene fuels. It therefore can be used to blend with other kerosene base fuels, e.g. those having an (unacceptably) high density and/or relatively low energy content.

The subject invention accordingly also provides the use of a kerosene base fuel according to the invention as a blending component. The kerosene base fuel may for example be used as a diluent in a fuel composition comprising a petroleum based kerosene base fuel having a higher density and a lower energy content than that of the kerosene base fuel, to increase the energy density of the fuel composition above that of the petroleum derived kerosene fuel.

The kerosene base fuel according to the present invention preferably has a density of at least 0.770 g/cm³ at 15° C. to about 0.840 g/cm³, according to ASTM D1655. Preferably the fuel according to the present invention has a relative density of between about 0.775 and 0.810 g/cm³ at 15° C., more preferably a relative density of between about 0.780 and 0.805 at 15° C., and most preferably a relative density of between about 0.785 and 0.800 at 15° C.

Accordingly, the kerosene base fuel according to the invention preferably has a density from 775 to 810 kg/m³ at 15° C., as determined according to ASTM D4502. More preferably, the density is less than 805, yet more preferably below 801, yet more preferably below 799, and most preferably below 795 kg/m³ at 15° C., as determined according to ASTM D4502.

The kerosene base fuel according to the invention can be employed as a light fuel component, thereby making use of its high energy content for aircraft that is not volume restrained. This allows longer-range flights at the same fuel weight, or reduction of the strength required for typical airplanes related to the weight of the fuel. The latter may allow for further weight savings, thereby again extending the possible range.

The kerosene base fuel according to the invention preferably has a near heat of combustion of or above 43.0 MJ/kg, as determined according to ASTM Method D4809, more preferably of or above 43.1 MJ/kg, yet more preferably above 43.2 MJ/kg.

The kerosene base fuel according to the invention preferably comprises less than 2% by weight, more preferably less than 1.8% wt., again more preferably less than 1.7% wt. of olefins, as determined according to ASTM method D1319.

The kerosene fuel base fuel according to the invention further preferably has a freeze point below −40° C., more preferably has a freeze point below −45 ° C., again more preferably below −50° C., and yet more preferably below −55° C., as determined according to ASTM method D2328.

Due to a high content of paraffins, the kerosene base fuel of the present invention may have excellent combustion properties. These include good properties when employed as transportation fuel for compression ignition engines. Accordingly, the kerosene base fuel preferably has a cetane index (ASTM D976) of above 40, preferably above 41, more preferably above 43, yet more preferably above 45, again more preferably above 48, and most preferably above 50.

The kerosene base fuel according to the present invention may also be used as part of a blendstock for use in hydrocarbon fuel-powered equipment, such as camp stoves, chainsaws, generators, and the like. The fuel according to the present invention may be used in various hydrocarbon fuel-powered machines. Furthermore, the high flash point and the high energy content at lower density may render the kerosene base fuel of the present invention suitable for use in diesel engines as well, thus improving applicability of the fuel. These benefits can also be useful in common vehicle and off-road diesel fuels. The kerosene base fuel according to the invention can be blended with highly aromatic conventional petroleum fuels, or highly paraffinic Fischer-Tropsch derived fuels, depending on the desired properties.

Combustion properties of the fuels of the present invention may include smoke points above 25 mm. The kerosene base fuel preferably has a smoke point above 25 mm, as determined by ASTM method D1322, and a flash point above 40° C., as determined according to ASTM method D93. The smoke point preferably is above 30 mm, more preferably above 35 mm, again preferably above 35 mm, and yet more preferably above 38 mm, as determined by ASTM method D1322.

The use of the, highly paraffinic, kerosene base fuel in fuel compositions for domestic heating, lighting and cooking permits exceptionally low NOx and soot emissions, while the low aromaticity and absence of polyaromatic compounds allows safe handling, for instance in fan heaters as usually employed in Japan.

The kerosene base fuel is also ideally employed for domestic heating appliances such as evaporator burners and pressure jet burners provided with a flame detector.

These detectors act as a safety measure by monitoring the constant presence of a flame. Many of the flame detectors in service today are based on optical measurements (e.g. photo cells) and detect a signal at a particular wavelength of light, in particular the light emitted by the flame of mineral oil-derived fuels in the visible yellow and/or red light spectrum. The kerosene base fuels permit the use of such appliances without the need for reformulation of the fuels, as has been reported for Fischer-Tropsch derived heating fuels.

The kerosene base fuel according to the invention further preferably comprises less than or equal to 15 ppm sulphur, more preferably less than 10 ppm, again more preferably less than 5 ppm and most preferably less than 3 ppmw of sulphur. The kerosene base fuel according to the invention further preferably comprises less than or equal to 10 ppm nitrogen, more preferably less than 8 ppm nitrogen, and yet more preferably less than 5 ppm nitrogen.

Although the origin of the kerosene base fuel according to the invention could be other hydrocarbonaceous products, such as certain mineral crude oils, tar sands or similar products, the kerosene base fuel component according to the invention is preferably derived from kerogen from oil shale. More preferably the kerosene base fuel according to invention is derived from the pyrolysis product of an in-situ conversion of kerogen, which may result in a lower average molecular weight and lower olefin content as compared to full range shale oil. The term “pyrolysis product” herein refers to a fluid produced substantially during pyrolysis of hydrocarbons. As used herein, a “pyrolysis zone” refers to a volume of hydrocarbon containing formation that is reacted or reacting to form a pyrolysis product. The pyrolysis product may be obtained either from an in-situ process, wherein the heat is generate in a kerogen containing formation to produce a pyrolysis product, or a to a surface retorting of kerogenic material. Preferably, the pyrolysis product is obtained in the in-situ process, since it then has a lower amount of higher molecular weight components that require further conversion to obtain a product in the kerosene boiling range. A further advantage is that the composition of the pyrolysis product of the in-situ process makes it better suited as a starting material. The kerosene base fuel may contain one or more metal compounds, such calcium, magnesium and manganese salts or compounds, and boron containing compounds. The calcium, magnesium and manganese compounds may be present in an amount of from 20-40 ppbw, while the boron compounds may be present in an amount of from 50 to 500 ppbw. The presence of these compounds may improve certain properties, for example properties related to stability.

An example of such a process is the process disclosed I EP-A-1276959, wherein a system of heat injection and hydrocarbon fluid production wells for use in the method according to the invention and pyrolysis products having a low olefin content (e.g.<10% by weight) and low average carbon number (e.g.<35) which are obtainable by the in-situ pyrolysis method and system are described in some detail.

A kerosene product may be obtained for example by fractionation, followed by hydrotreatment of the pyrolysis product.

Hydrotreatment can involve hydrocracking to adjust the boiling range, as described in e.g. GB-B-2077289 and EP-A-0147873, and hydroisomerisation. The latter can improve base fuel cold flow properties by increasing the proportion of branched paraffins.

Other post-synthesis treatments, such as polymerisation, alkylation, distillation, cracking-decarboxylation, isomerisation and hydroreforming, may also be employed to modify the properties of the in-situ products, such as for example disclosed in WO/2007111642.

In accordance with the present invention, the kerosene base fuel may suitably comprise at least 60% w, preferably at least 65% w, more preferably at least 68% w, most preferably at least 69% w, of paraffinic components. Of these, preferably at least 40% w are naphthenic, i.e. cyclic paraffinic components, the remainder preferably being composed of normal and iso-paraffins.

The subject invention further also provides a fuel composition comprising 0.1 to 99.9 volume % of the kerosene base fuel, and further at least one additive. Other base fuels may be present as well. More preferably, the kerosene base fuel is present in the fuel composition in an amount of 0.1 to 81% v or 5 to 99.9% v, most preferably in an amount of 30 to 65% v. The invention further provides the use of the kerosene base fuel in a fuel composition comprising a petroleum based kerosene fuel, a Fischer-Tropsch derived kerosene fuel, or another base fuel. The fuel composition may contain 5% v or greater, preferably 10% v or greater, or more preferably 25% v or greater, of the kerosene base fuel according to the invention. The kerosene base fuel can also be used as the sole base fuel in a kerosene fuel.

The components of the kerosene base fuel (or the majority, for instance 95% w or greater, thereof) preferably have boiling points within the kerosene fuel range, i.e. from 130 to 300° C. Preferably the kerosene base fuel has a 90% v/v distillation temperature (T90) in the range from 180 to 220° C., preferably 180 to 200° C.

In the context of the present invention, “use” of a fuel component in a fuel composition means incorporating the component into the composition, typically as a blend (i.e. a physical mixture) with one or more other fuel components, conveniently before the composition is introduced into an engine. The fuel compositions provided by the present invention can be used in aviation engines, such as jet engines or aero diesel engines, but also in other suitable power sources.

Each base fuel may itself comprise a mixture of two or more different fuel components, and/or be additivated as described below.

The subject invention further also provides a method of operating a jet engine or a compression ignition (diesel) engine and/or an aircraft, which is powered by one of more of said engines, which method involves introducing into said engine a fuel composition comprising the kerosene base fuel according to the invention.

The subject invention further also provides a process for the preparation of a fuel composition which process involves blending a petroleum derived kerosene fuel with a kerosene base fuel component according to the invention. The kerosene base fuel according to the invention preferably comprises less than 2% w olefins, preferably less than 1.8% w of olefins (ASTM D1319).

The present invention further provides a method of operating a jet engine or a diesel engine and/or an aircraft which is powered by one of more of said engines, which method involves introducing into said engine a fuel composition according to the present invention.

The present invention still further provides a process for the preparation of a fuel composition which process involves blending a petroleum derived kerosene fuel with the kerosene base fuel.

The kerosene base fuel preferably has a kinematic viscosity at −20° C. (ASTM D445) from 1.2 to 8.0 mm²/s.

The weight ratio of naphthenic to normal to iso-paraffins will preferably be in the ranges indicated above. The actual value for this ratio may be determined, in part, by the hydroconversion process used to prepare the kerosene from the kerogen, or the in-situ synthetic crude.

The aromatics content of the kerosene base fuel, as determined by ASTM D4629, will preferably be below 25% w, more preferably below 20% w, and more preferably below 15% w, yet more preferably below 10% w, and more preferably below 9% w.

The kerosene component according to the present invention will preferably have a kinematic viscosity from 1.2 to 6, preferably from 2 to 5, more preferably from 2 to 3.5, mm²/s at −20° C.; and a sulphur content of 20 ppmw (parts per million by weight) or less, preferably of 5 ppmw or less.

The kerosene fuel preferably contains no more than 3000 ppmw sulphur, more preferably no more than 2000 ppmw, or no more than 1000 ppmw, or no more than 500 ppmw sulphur.

The kerosene fuel may itself be additivated (additive-containing) or unadditivated (additive-free). If additivated, e.g. at the refinery or in later stages of fuel distribution, it may contain minor amounts of one or more additives selected for example from anti-static agents (e.g. STADIS™ 450 (ex. Octel)), antioxidants (e.g. substituted tertiary butyl phenols), metal deactivator additives (e.g. N,N′-disalicylidene 1,2-propanediamine), fuel system ice improver additives (e.g. diethylene glycol monomethyl ether), corrosion inhibitor/lubricity improver additives (e.g. APOLLO™ PRI 19 (ex. Apollo), DCI 4A (ex. Octel), NALCO™ 5403 (ex. Nalco)), or thermal stability improving additives (e.g. APA 101™, (ex. Shell)) that are approved in international civil and/or military jet fuel specifications.

Unless otherwise stated, the (active matter) concentration of each such additional component in the additivated fuel composition is at levels required or allowed in international jet fuel specifications.

In this specification, amounts (concentrations, % v, ppmw, wt %) of components are of active matter, i.e. exclusive of volatile solvents/diluent materials.

The present invention is advantageously applicable where the fuel composition is used or intended to be used in a jet engine, a direct injection diesel engine, for example of the rotary pump, in-line pump, unit pump, electronic unit injector or common rail type, or in an indirect injection diesel engine. It may be of special value for rotary pump engines, and in other diesel engines which rely on mechanical actuation of the fuel injectors and/or a low pressure pilot injection system. The fuel composition may be suitable for use in heavy and/or light duty diesel engines. The present invention may lead to any of a number of advantageous effects, including good engine low temperature performance.

### EXAMPLES

The present invention will now be described by way of example.

The kerosene base fuel example 1 and comparative example 1 contained Ionox 75 (RDE/A/609) as approved jet fuel antioxidant at approximately 20 mg/L.

TABLE 1

| Fuel | Description |
|---|---|
| Example 1 | Kerosene base fuel, comprising 19 mg/L of |
| | antioxidant Ionox 75 (RDE/A/609) |
| Comparative | Mineral oil based hydroprocessed jet fuel, |
| Example A | with 19 mg/L of antioxidant Ionox 75 |
| | (RDE/A/609). |
| Comparative | Shale oil derived Kerosene base fuel 2, |
| Example B | surface retorted and severely hydrotreated |

Key properties of the kerosene base fuel of example 1 and the petroleum derived fuel of comparative example A, measured using ASTM methods approved in jet fuel specifications, are listed in Tables 2 and 3, respectively.

The kerosene base fuel of example 1 was a wide cut kerosene (ranging from C7 to C20), compared to a more typical boiling range of 130 to 260° C. for the petroleum derived fuel of comparative example A, Jet A-1.

The kerosene base fuel is highly paraffinic (greater than 85% paraffins, and more than 30% w naphthenes (cycloparaffins), the remainder being normal and iso paraffin, and approximately 4% monoaromatic compounds. The composition was determined according to the method disclosed in WO2007/071634.

TABLE 2
GCxGC compositional data (ignoring anything
recorded below 0.003% weight)

| | | | Comparative |
|---|---|---|---|
| | | | Example A |
| GCxGC- Summary | | Example 1 | (Jet A-1) |
| Carbon Range | | 7 to 20 | 7 to 15 |
| N paraffins | % w | 29.44 | 20.45 |
| Iso paraffins | % w | 25.98 | 23.12 |
| Naphthenics | % w | 31.23 | 27.39 |
| (cycloparaffins) | | | |
| DiNaphthenics | % w | 8.63 | 7.05 |
| Monoaromatics | % w | 4.19 | 15.90 |
| Diaromatics | % w | 0.53 | 3.07 |
| Naphthenic | % w | 0.01 | 3.01 |
| Monoaromatics | | | |
| Naphthenic | % w | 0 | 0 |
| Diaromatics | | | |
| Triaromatics | % w | 0 | 0 |
| Ratio | | 1:0.94:0.83 | 1:0.75:0.84 |
| napthenics/n-/i- | | | |
| paraffins | | | |
| Ratio i-/n- | | 0.88 | 1.13 |
| paraffins | | | |

The kerosene base fuels were subjected to a number of typical tests, and compared to surface retorted and subsequently refined oil shale kerosene products(see Table 3).

TABLE 3
Test Results for Kerosene base fuel:
Comparison with Shale Oil derived Jet fuel component

| | | | Comparative Example |
|---|---|---|---|
| Property | Method | Example 1 | B (Paraho II) |
| Saybolt Colour | D156 | 25 | n.d. |
| Acids, total, (mg | D3242/ | <0.001 | 0.01 |
| KOH/g) | IP 354 | | |
| Sulphur, | ISO20884/ | 0.0003 | 0.002 |
| total (% m/m) | IP497 | | |
| Sulphur | IP336 | <0.01 | Not reported |
| content (% m/m) | | | |
| Mercaptan | D3227 | <0.0003 | |
| sulphur (% m/m) | | | |
| Aromatics, FIA (% V) | D1319 | 3.2 | 21.3 |
| Distillation | D86 | | |
| Final Boiling | | | |
| Point, ° C. | | | |
| Initial Boiling | | 155.2 | 178 |
| Point, ° C. | | | |
| 10% recovery, ° C. | | 167.6 | Not reported |
| 20% recovery, ° C. | | 172.1 | Not reported |
| 50% recovery, ° C. | | 186.4 | 201 |
| 90% recovery, ° C. | | 217.0 | Not reported |
| Final Boiling | | 249.0 | 257 |
| Point, ° C. | | | |
| Residue (% V/V) | | 0.7 | Not reported |
| Loss (% V/V) | | 0.0 | Not reported |
| Abel Flash point, | IP170 | 41.5 | |
| ° C. | | | |
| Density @ | D4052 | 777.3 | ~804.4 |
| 15° C., (Kg/m³) | | | |
| FLUIDITY | | | |
| Freezing point (° C.) | D2386 | −53.5 | −52 |
| Viscosity at | D445 | 3.347 | 4.19 |
| −20° C. (cSt) | | | |
| (THERMAL) | | | |
| STABILITY | | | |
| JFTOT at 260° C. | D3241 | <1 | 2 |
| Pressure drop, | | <1 | n.d. |
| (mmHg) | | | |
| Visual tube rating | | 1 | n.d. |
| COMBUSTION | | | |
| Specific energy¹, | D3338 | 43.7 | 42.82 |
| MJ/kg | | | |
| Smoke point, (mm) | D1322 | 39 | 20.2 |
| Naphthalene | D1840 | 0 | |
| content (% V/V) | | | |
| Existent gum | D381 | <1 | n.d. |
| (mg/100 mL) | | | |
| MSEP, without SDA | D3948 | 100 | n.d. |
| Copper strip | IP154 | 1A | |
| BOCLE wear scar | D5001 | 0.86 | |
| diameter², (mm) | | | |
| Conductivity, | D2624/ | 0 | |
| (pS/m) at 23° C. | IP274 | | |
| Nitrogen, ppm | | 0.31 | n.d. |
| Cu corrosion at | | 1A | 1A |
| 100° C. | | | |
| Cetane index, calc | | 47.8 | n.d. |
| | | (D976) | |

¹Neat Heat of Combustion
²Average of 2 Tests

The following test (Table 4) shows the thermal stability of the kerosene base fuel according to the invention. Such thermal stability was not achieved by the mineral crude derived Jet Fuel Al of comparative example A. The first test was an oxygen flask test to see the effect of the

TABLE 4
Additional “Aviation Fuel” Test Results for Example 1

| Property | Method | Units | Result |
|---|---|---|---|
| (THERMAL) STABILITY | | | |
| JFTOT breakpoint | D3241 | (° C.) | 380 or higher |
| Test temperature (° C.) | | Rating | Result |
| 340 | | <2 or 2 | Pass |
| 350 | | <2 or 2 | Pass |
| 360 | | 1 | Pass |
| 380 | | <2 | Pass |

The above examples show the strong thermal stability performance of the kerosene base fuels according to the invention, along with other favourable properties such as low density at high energy content.

1. A kerosene base fuel having an initial boiling point in the range 130 to 160° C. and a final boiling point in the range 250 to 300° C. as determined according to ASTM method D86, and comprising less than 15% by weight of aromatic compounds, and at least 80% by weight of aliphatic hydrocarbons, of which at least 20% by volume are n-paraffins and at least 25% by volume are cycloparaffins, as determined by according to ASTM method D2425.

2. A kerosene base fuel according to claim 1, wherein the aromatic compounds comprise monoaromatic compounds and diaromatic compounds and wherein the ratio of monoaromatic compounds to diaromatic compounds is above 9.0, as determined by ASTM method D6379.

3. A kerosene base fuel according to claim 1, wherein more then 50% of the aromatic compounds are naphthenic aromatic compounds.

4. A kerosene base fuel according to claim 1, having a density from 775 to 801 kg/m³ at 15° C., as determined according to ASTM method D4502.

5. A kerosene base fuel according to claim 1, having a near heat of combustion above 43.0 MJ/kg, as determined according to ASTM Method D4809.

6. A kerosene base fuel according to claim 1, comprising less than 2% by weight of olefins, as determined according to ASTM method D1319.

7. A kerosene fuel base fuel according to claim 1, having a freeze point below −40° C., as determined according to ASTM method D2328.

8. A kerosene base fuel according to claim 1, having a smoke point above 25 mm, as determined by ASTM method D1322, and a flash point above 40° C., as determined according to ASTM method D93.

9. A kerosene base fuel according to claim 1, comprising less than or equal to 10 ppm sulphur, and less than or equal to 10 ppm nitrogen.

10. A kerosene base fuel according to claim 1, wherein the kerosene base fuel is derived from kerogen from oil shale.

11. A kerosene base fuel according to claim 10, wherein the kerosene base fuel is derived from the pyrolysis product of an in-situ conversion of kerogen.

12. A fuel composition comprising 0.1 to 99.9 volume % of the kerosene base fuel according to claim 1 and further comprising at least one additive.

13. (canceled)

14. (canceled)

15. A method of operating a jet engine or a compression ignition (diesel) engine and/or an aircraft which is powered by one of more of said engines, which method involves introducing into said engine a fuel composition comprising the kerosene base fuel according to claim 1.
